(19) United States
(12) Patent Application Publication
(10) Pub. No.: US 2005/0039501 A1
(43) Pub. Date: Feb. 24, 2005

(54) Locking apparatus with double locking units

(76) Inventor: Chun-Te Yu, Fu-Hsing Hsiang (TW)

Correspondence Address: BRUCE H. TROXELL;SUITE 1404, 5205 LEESBURG PIKE, FALLS CHURCH, VA, 22041, US

(21) Appl. No.: 10/681,239

(22) Filed: Oct. 9, 2003

(30) Foreign Application Priority Data
Aug. 22, 2003 (TW) 92215321

(51) Int. Cl. E05B 37/02

(52) U.S. Cl. 70/29; 70/46

(57) ABSTRACT

A locking apparatus with double locking units including a housing defining a cavity, a numeral wheel locking unit and a controlling unit mounted in the cavity and a lock hook or rod member. The lock hook or rod member has a fixed end connected with the lock core of the locking unit and a free end which is detained by the controlling unit in a locked state. The controlling unit includes a rotary section in which a key can be inserted and a reactor and a driven unit disposed on the rotary section. The driven unit is formed with a notch for detaining the free end of the lock hook or rod member. The reactor and the driven unit are rotatable with the key to release or detain the free end of the lock hook or rod member.

### BACKGROUND OF THE INVENTION

The present invention is related to a locking apparatus meeting the regulation of U.S. customs, and more particularly to a locking apparatus with both numeral wheel locking unit and key-drivable locking unit.

The conventional locking apparatuses include numeral locks, press key type locks and key-driven locks. These locking apparatuses are widely applied to various fields. For example, Taiwanese Patent Nos. 32470 and 46563 and Publication Nos. 498918 and 369068 respectively disclose numeral locks and key-driven locks applicable to baggage case or suitcase.

Practically, it is known that when checked by U.S. customs workers, in case it is found the customs workers that the contents of the baggage case or suitcase are suspicious, the customs workers are authorized by U.S. government to forcedly break off the lock of the baggage case or suitcase and open the same for checking the contents. The damaged lock will be a loss of a user and will lead to trouble and inconvenience to the user, especially during travel.

In order to improve the above situation, U.S. government and customs regulate that the lock manufacturers must provide a standard key for the customs for opening all the locks manufactured by the manufacturers. According to this regulation, there are six lock manufacturers all over the world (including two manufacturers in Taiwan) are allowed to manufacture such locks. The applicant is one of the two manufacturer in Taiwan. When meeting the above regulation, some issues must be considered in designing and manufacturing such locks. For example, it is considered how to combine the numeral wheel locking unit and key-driven locking unit in the locking apparatus to together control the lock hook thereof without affecting or interfering with the original operation and function of the locking apparatus. Also, the manufacturers must consider the cooperation of the two locking units and the state of one of the locking units when the other is operated. These issues are not discussed in the above Patents.

### SUMMARY OF THE INVENTION

It is therefore a primary object of the present invention to provide a locking apparatus with double locking units. The locking apparatus includes a numeral wheel locking unit and a key-drivable controlling unit for together detaining a lock hook or rod member. When the numeral wheel locking unit or the key-drivable controlling unit is unlocked, one end of the lock hook or rod member can be rotated or moved.

According to the above object, the locking apparatus of the present invention includes a housing defining a cavity, a locking unit and a controlling unit mounted in the cavity and a lock hook or rod member. When the numeral wheels are turned to a set number, the lock core is permitted to freely axially move. The lock hook or rod member has a fixed end connected with a lock core of the locking unit and a free end which is detained by the controlling unit in a locked state and rotatable or movable in an unlocked state.

The controlling unit includes a rotary section in which a key can be inserted and a reactor and a driven unit disposed on the rotary section for detaining the free end of the lock hook or rod member in the locked state. The reactor and the driven unit are movable with the key to release or detain the free end of the lock hook or rod member.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a plane assembled view according to FIG. 1;

FIG. 2A is a top view according to FIG. 2;

FIG. 3 is a plane assembled view according to FIG. 2, in which the numeral wheels are turned to a set number to form an unlocked state;

FIG. 4 is a plane assembled view according to FIG. 2, showing that a key is used to drive the controlling unit to form an unlocked state;

FIG. 4A is a top view according to FIG. 4;

FIG. 5 is a plane assembled view of a second embodiment of the present invention;

FIG. 5A is a perspective exploded view of the second embodiment of the present invention;

FIG. 6 is a plane assembled view according to FIG. 5, in which the numeral wheels are turned to a set number to form an unlocked state;

FIG. 7 is a plane assembled view according to FIG. 5, showing that a key is used to drive the controlling unit to form an unlocked state;

FIG. 8 is a plane assembled view of a third embodiment of the present invention;

FIG. 8A is a sectional view taken along line A-A of FIG. 8;

FIG. 8B is a top view according to FIG. 8;

FIG. 9 is a plane assembled view according to FIG. 8, in which the numeral wheels are turned to a set number to form an unlocked state;

FIG. 10 is a plane assembled view according to FIG. 8, showing that a key is used to drive the controlling unit to form an unlocked state;

FIG. 10A is a sectional view taken along line A-A of FIG. 10; and

FIG. 10B is a top view according to FIG. 10.

### DETAILED DESCRIPTION OF THE PREFERRED EMBODIMENTS

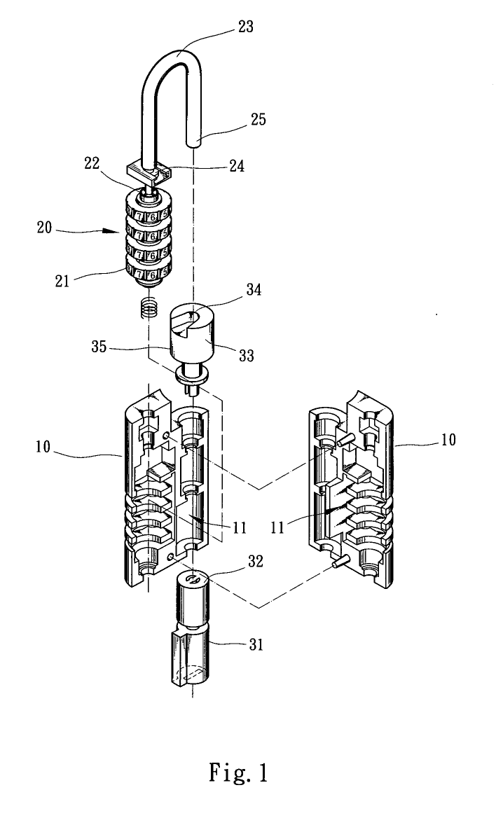

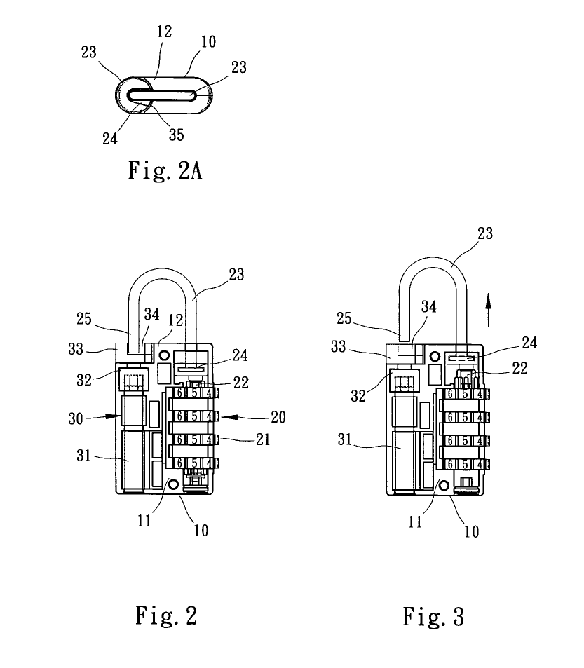

Please refer to FIGS. 1 and 2. The present invention includes a housing 10 defining a cavity 11. A numeral wheel locking unit 20 and a key-drivable controlling unit 30 are respectively mounted in two sides of the cavity 11. In a preferred embodiment, the numeral wheel locking unit 20 is a standard numeral lock model which includes multiple numeral wheels 21 and a lock core 22 combined therewith. Each numeral wheel 21 partially protrudes from the housing 10 for a user to turn. When the numeral wheels 21 are turned to a set number, the lock core 22 is permitted to freely axially move as shown in FIG. 3. (This pertains to prior art and will not be further described hereinafter.)

A fixed end 24 of a lock hook or rod member 23 is connected with the head section of the lock core 22. The lock hook or rod member 23 is movable along with the lock core 22. The lock hook or rod member 23 has a free end 25 opposite to the fixed end 24. The free end 25 can be detained or released by the controlling unit 30.

In the first embodiment of the present invention as shown in FIGS. 1 and 2, the controlling unit 30 includes a rotary section 31. A key 40 can be inserted into the rotary section 31 to drive and rotate the rotary section 31. A reactor 32 is mounted on upper side of the rotary section 31 and connected with a driven unit 33. The driven unit 33 outward protrudes from the housing 10. The reactor 32 and the driven unit 33 are rotatable along with the rotary section 31. The driven unit 33 is formed with a notch 34 having an opening 35. The free end 25 of the lock hook or rod member 23 is coaxially detained in the notch 34. FIG. 2A shows that the opening 35 faces the fixed end 24 of the lock hook or rod member 23 and blocked by a ridge section 12 of the housing 10. Under such circumstance, the free end 25 of the lock hook or rod member 23 cannot leave the notch 34. Alternatively, the opening 35 can be directed in reverse to the direction as shown in FIG. 2A to achieve the same effect.

Referring to FIG. 3, when the numeral wheels 21 are turned to a set number, the lock core 22 is permitted to freely axially move, whereby the lock hook or rod member 23 can be moved upward. At this time, the free end 25 of the lock hook or rod member 23 can leave the notch 34 of the driven unit 33 to form an unlocked state.

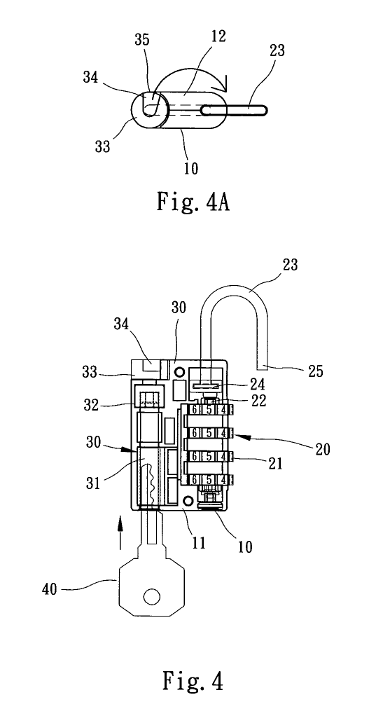

FIG. 2 shows the locked state of the present invention. When a key 40 is inserted into the rotary section 31 of the controlling unit 30 in a direction as shown by the arrow of FIG. 4, the rotary section 31 can be rotated along with the key 40. At this time, the reactor 32 and the driven unit 33 can be moved along with the rotary section 31. In a preferred embodiment, the angular displacement of the driven unit 33 is set smaller than or equal to 90 degrees. Accordingly, the opening 35 of the notch of the driven unit 33 can be turned to a position as shown in FIG. 4A to release the free end 25 of the lock hook or rod member 23. At this time, the free end 25 of the lock hook or rod member 23 can be turned through the opening 35 out of the notch 34 of the driven unit 33 to form an unlocked state.

FIG. 4 shows the position of the fixed end 24 of the lock hook or rod member 23. In comparison with the position of the fixed end 24 in the unlocked state as shown in FIG. 3, the fixed end 24 is positioned at a lowest point in the locked state as shown in FIG. 2. Therefore, although the numeral wheels 21 of the locking unit 20 are not turned to the set unlocking number, a customs worker can use a standard key 40 to drive the controlling unit 30 and release the free end 25 of the lock hook or rod member 23 from detention.

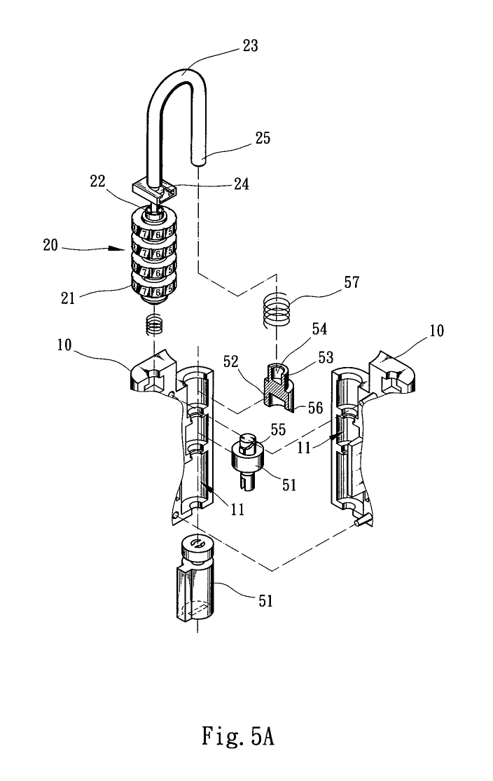

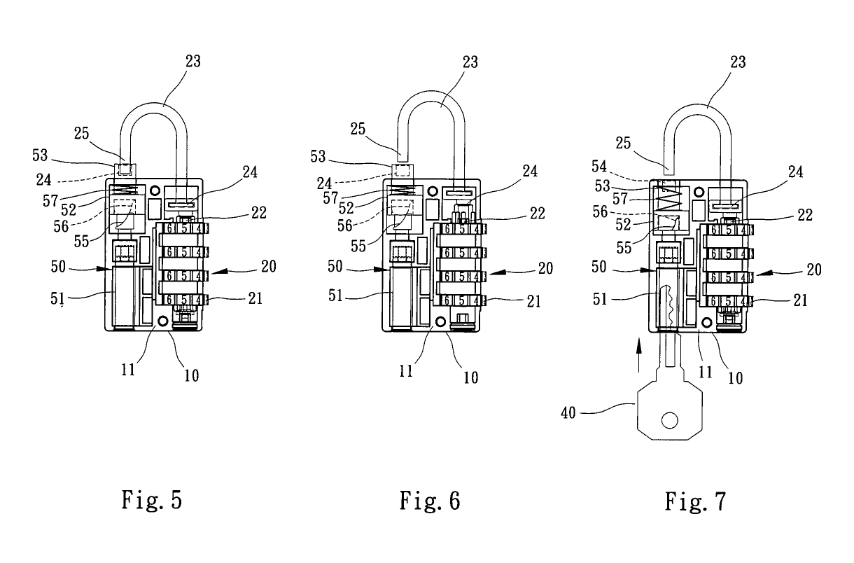

FIGS. 5 and 5A show a second embodiment of the present invention, in which the structure of the controlling unit is modified and denoted by reference numeral 50. The controlling unit 50 includes a rotary section 51 in which a key 40 can be inserted. A head end of the rotary section 51 has a curved slope or a male spiral section 55. A reactor 52 is mounted on upper side of the rotary section 51 and connected with a driven unit 53. The driven unit 53 outward protrudes from the housing 10. The driven unit 53 is formed with a notch 54. The free end 25 of the lock hook or rod member 23 is coaxially detained in the notch 54. In this embodiment, the reactor 52 has a curved slope or female spiral section 56 formed inside the reactor 52. At least a part of the curved slope or female spiral section 56 contacts with or engages with the curved slope or male spiral section 55 of the rotary section 51.

FIG. 6 shows that when the numeral wheels 21 are turned to a set number, the lock core 22 is permitted to axially move, whereby the lock hook or rod member 23 can be moved upward. At this time, the free end 25 of the lock hook or rod member 23 can leave the notch 54 of the driven unit 53 to form an unlocked state. In a preferred embodiment, a spring 57 is disposed between the reactor 52 and the driven unit 53 for restoring the reactor 52 and the driven unit 53 to their home positions and stabilizing the movement thereof.

FIG. 5 shows the locked state of this embodiment of the present invention. When a key 40 is inserted into the rotary section 51 of the controlling unit 50 in a direction as shown by the arrow of FIG. 7, the rotary section 51 can be rotated along with the key 40. The curved slope or male spiral section 55 of the rotary section 51 contacts with or engages with the curved slope or female spiral section 56 of the reactor 52. Therefore, when the rotary section 51 is turned with the key 4, the contacting portions of the curved slopes or spiral sections of the reactor 52 and the rotary section 51 are forcedly enlarged. Accordingly, the driven unit 53 is driven to axially downward move. At this time, the notch 54 leaves the free end 25 of the lock hook or rod member 23 as shown in FIG. 7 and the free end 25 can be freely rotated. It should be noted that when the key 40 is turned, by means of the engaged curved slopes or male and female spiral sections 55, 56, the reactor 52 and the driven unit 53 are forced by the rotary section 51 to axially move.

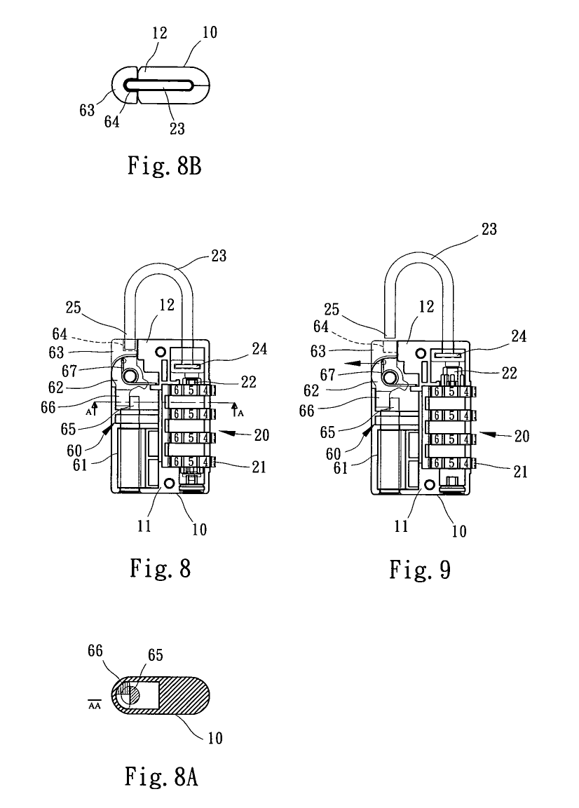

FIG. 8 shows a third embodiment of the present invention, in which the structure of the controlling unit is modified and denoted by reference numeral 60. The controlling unit 60 includes a rotary section 61 in which a key 40 can be inserted. A head end of the rotary section 61 has a switch 65. In this embodiment, the switch 65 is a semicylindrical body as shown in FIG. 8A. A reactor 62 is mounted on upper side of the rotary section 61 and connected with a driven unit 63. The driven unit 63 is formed with a dent 64 having an opening. The opening of the dent 64 faces the fixed end 24 of the lock hook or rod member 23. The driven unit 63 and the ridge section 12 of the housing 10 together detain the free end 25 of the lock hook or rod member 23 as shown in FIG. 8B.

The lower end of the reactor 62 is formed with a key 66 corresponding to the switch 65 of the rotary section. The reactor 62 has a spring 67 which always exerts an outward swinging force onto the driven unit 63 disposed on the reactor 62. FIG. 8A shows that the key 66 is a substantially quarter-cylindrical body which is at least partially stopped by the switch 65 of the rotary section 61. That is, the spring 67 always exerts a force onto the driven unit 63 disposed on the reactor 62, making the driven unit 63 tend to swing to outer side of the housing 10. Relatively, the spring 67 makes the key 66 on lower side of the reactor 62 tend to swing to inner side of the housing 10. However, the switch 65 stops the key 66 from swinging to the inner side of the housing 10.

Referring to FIG. 9, when the numeral wheels 21 are turned to a set number, the lock core 22 is permitted to freely axially move, whereby the lock hook or rod member 23 can be moved upward. At this time, the free end 25 of the lock hook or rod member 23 can leave the dent 64 of the driven unit 63 to form an unlocked state.

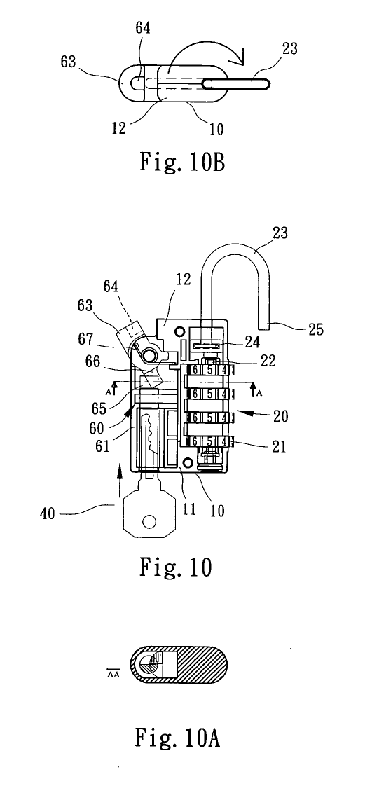

FIG. 8 shows the locked state of this embodiment of the present invention. When a key 40 is inserted into the rotary section 61 of the controlling unit 60 in a direction as shown by the arrow of FIG. 10, the rotary section 61 can be rotated along with the key 40. In a preferred embodiment, the angular displacement of the rotary section 61 is set about 90 degrees. FIG. 10A shows the position of the switch 65 of the rotary section 61 after the rotary section 61 is rotated. At this time, the switch 65 leaves the position where the key 66 of the reactor 62 is stopped. Accordingly, the spring 67 forces the reactor 62 and the driven unit 63 to swing to outer side of the housing 10. Therefore, the dent 64 of the driven unit 63 is moved to the position as shown in FIG. 10B to release the free end 25 of the lock hook or rod member 23 from detention. At this time, the free end 25 can be turned in a direction as shown by the arrow to leave the dent 64 and form an unlocked state.

In the above locking apparatus with double locking units, the numeral wheel locking unit 20 and the key-drivable controlling unit 30, 50, 60 are combined together. Such locking apparatus meets the regulation of U.S. customs without affecting or interfering with the original operation and function of the locking apparatus.

The above embodiments are only used to illustrate the present invention, not intended to limit the scope thereof. Many modifications of the above embodiments can be made without departing from the spirit of the present invention.

1. A locking apparatus with double locking units, comprising:
a housing defining a cavity, a locking unit and a controlling unit being mounted in the cavity; and
a lock hook or rod member having a fixed end connected with the locking unit and a free end which is detained by the controlling unit in a locked state, the controlling unit including:
a rotary section in which a key can be inserted; and
a reactor and a driven unit disposed on the rotary section, the driven unit being formed with a notch for detaining the free end of the lock hook or rod member in the locked state, whereby the reactor and the driven unit are movable with the key to release the free end of the lock hook or rod member from the notch of the driven unit.

2. The locking apparatus with double locking units as claimed in claim 1, wherein the controlling unit includes a rotary section in which a key can be inserted, the rotary section being rotatable with the key, a head end of the rotary section having a spiral section, the reactor having another spiral section formed inside the reactor corresponding to the spiral section of the head end of the rotary section, at least a part of the spiral section of the reactor being always engaged with the spiral section of the rotary section, whereby when the rotary section is rotated, the driven unit is axially linearly moved up or down, in ascending travel, the driven unit detaining the free end of the lock hook or rod member, while in descending travel, the driven unit releasing the free end of the lock hook or rod member.

3. The locking apparatus with double locking units as claimed in claim 1, wherein the controlling unit includes a rotary section in which a key can be inserted, the rotary section being rotatable with the key, a head end of the rotary section having a switch, a lower end of the reactor being formed with a key, whereby in a locked state, the key is partially stopped by the switch, while in an unlocked state, the key is not stopped by the switch, a driven unit being formed on upper end of the reactor, the reactor having a spring which always exerts a force onto the driven unit, whereby the driven unit tends to swing in such a direction as to release the free end.

4. The locking apparatus with double locking units as claimed in claim 1, wherein the locking unit includes multiple numeral wheels and a lock core connected with the fixed end of the lock hook or rod member, whereby when the numeral wheels are turned to a set number, the lock core is permitted to freely axially move.

5. The locking apparatus with double locking units as claimed in claim 2, wherein the locking unit includes multiple numeral wheels and a lock core connected with the fixed end of the lock hook or rod member, whereby when the numeral wheels are turned to a set number, the lock core is permitted to freely axially move.

6. The locking apparatus with double locking units as claimed in claim 3, wherein the locking unit includes multiple numeral wheels and a lock core connected with the fixed end of the lock hook or rod member, whereby when the numeral wheels are turned to a set number, the lock core is permitted to freely axially move.

7. The locking apparatus with double locking units as claimed in claim 1, wherein the notch of the driven unit has an opening, whereby in the locked state, the opening faces the lock hook or rod member and the driven unit and the housing together enclose the lock hook or rod member, while after the driven unit is rotated with the key, the opening of the driven unit is moved to an open position for releasing the free end of the lock hook or rod member.

8. The locking apparatus with double locking units as claimed in claim 2, wherein the notch of the driven unit has an opening, whereby in the locked state, the opening faces the lock hook or rod member and the driven unit and the housing together enclose the lock hook or rod member, while after the driven unit is rotated with the key, the opening of the driven unit is moved to an open position for releasing the free end of the lock hook or rod member.

9. The locking apparatus with double locking units as claimed in claim 3, wherein the notch of the driven unit has an opening, whereby in the locked state, the opening faces the lock hook or rod member and the driven unit and the housing together enclose the lock hook or rod member, while after the driven unit is rotated with the key, the opening of the driven unit is moved to an open position for releasing the free end of the lock hook or rod member.

10. The locking apparatus with double locking units as claimed in claim 1, wherein the notch of the driven unit coaxially detains or releases the free end of the lock hook or rod member.

11. The locking apparatus with double locking units as claimed in claim 2, wherein the notch of the driven unit coaxially detains or releases the free end of the lock hook or rod member.

12. The locking apparatus with double locking units as claimed in claim 1, wherein a head end of the rotary section of the controlling unit has a curved slope and the reactor has another curved slope formed inside the reactor, at least a part of the curved slope of the reactor always contacting with the curved slope of the rotary section, whereby when the rotary section is rotated with the key, the driven unit is forcedly driven by the reactor to upward axially move.

13. The locking apparatus with double locking units as claimed in claim 12, wherein a spring is disposed between the reactor and the driven unit of the controlling unit.

14. The locking apparatus with double locking units as claimed in claim 2, wherein a head end of the rotary section of the controlling unit has a curved slope and the reactor has another curved slope formed inside the reactor, at least a part of the curved slope of the reactor always contacting with the curved slope of the rotary section, whereby when the rotary section is rotated with the key, the driven unit is forcedly driven by the reactor to upward axially move.

15. The locking apparatus with double locking units as claimed in claim 14, wherein a spring is disposed between the reactor and the driven unit of the controlling unit.

16. The locking apparatus with double locking units as claimed in claim 1, wherein a head end of the rotary section of the controlling unit has a switch, a lower end of the reactor being formed with a key which is at least partially stopped by the switch.

17. The locking apparatus with double locking units as claimed in claim 3, wherein a head end of the rotary section of the controlling unit has a switch, a lower end of the reactor being formed with a key which is at least partially stopped by the switch.

18. The locking apparatus with double locking units as claimed in claim 13, wherein the switch is a semicylindrical body, while the key of the reactor is a quarter-cylindrical body.

19. The locking apparatus with double locking units as claimed in claim 15, wherein the switch is a semicylindrical body, while the key of the reactor is a quarter-cylindrical body.
